(19) United States
(12) Patent Application Publication
(10) Pub. No.: US 2025/0151701 A1
(43) Pub. Date: May 15, 2025

(54) PET TOYS

(71) Applicant: Worldwise, Inc., Novato, CA (US)

(72) Inventors: Aimee Diskin, Napa, CA (US); Hannah Rosenberg, San Francisco, CA (US); Alessandro Pagura, San Francisco, CA (US); Cristen Underwood, Westminster, CO (US); Daniel Lee, Emeryville, CA (US)

(21) Appl. No.: 18/946,910

(22) Filed: Nov. 13, 2024

Related U.S. Application Data
(60) Provisional application No. 63/598,326, filed on Nov. 13, 2023.

(51) Int. Cl. A01K 15/02

(52) U.S. Cl. CPC A01K 15/025

(57) ABSTRACT

A pet toy includes a body portion having a helical shape and the body portion defines an outer width of the pet toy. The pet toy also includes a first end portion that extends from a top end of the body portion and a second end portion that extends from a body end of the body portion. The first and second end portions are free ends of the pet toy.

### CROSS-REFERENCE TO RELATED APPLICATIONS

The present application claims the benefit of U.S. Provisional Application Ser. No. 63/598,326, filed on Nov. 13, 2023, entitled PET TOYS (Attorney Docket No. 40472.04444), the entire disclosure of which is incorporated herein by reference in its entirety.

### TECHNICAL FIELD

The present application relates generally to pet toys and in particular to pet toys that continue moving once movement has been initiated.

### BACKGROUND

Dogs (and other pets) benefit from playing with toys that encourage interaction, are entertaining, and that are durable to withstand the kind of tough play in which dogs engage.

### SUMMARY

Exemplary embodiments of pet toys and methods of using the same are disclosed herein.

An example of a pet toy described herein includes a body portion having a helical shape, a first end portion that extends from a top end of the body portion, and a second end portion that extends from a bottom end of the body portion. The body portion defines an outer width of the pet toy. The first end is a free end of the pet toy and the second end is a free end of the pet toy.

Another example of a pet toy described herein includes a body portion, a top member that extends from a top end of the body portion, and a bottom member that extends from a bottom end of the body portion. The top member includes a saddled-shaped loop and the bottom member includes a saddle-shaped loop.

Still another example of a pet toy described herein includes a plurality of surfaces joined together by a plurality of edges to form a three-dimensional body. A first contact surface between the pet toy and a play surface is arranged on one of the plurality of edges. A second contact surface between the pet toy and the play surface is arranged on another of the plurality of edges or one of the plurality of surfaces.

A further understanding of the nature and advantages of the present invention are set forth in the following description and claims, particularly when considered in conjunction with the accompanying drawings in which like parts bear like reference numerals.

### BRIEF DESCRIPTION OF THE DRAWINGS

To further clarify various aspects of embodiments of the present disclosure, a more particular description of the certain embodiments will be made by reference to various aspects of the appended drawings. It is appreciated that these drawings depict only typical embodiments of the present disclosure and are therefore not to be considered limiting of the scope of the disclosure. Moreover, while the figures can be drawn to scale for some embodiments, the figures are not necessarily drawn to scale for all embodiments. Embodiments and other features and advantages of the present disclosure will be described and explained with additional specificity and detail through the use of the accompanying drawings in which:

FIG. 1 is a perspective view of an example pet toy;

FIG. 2 is a front view of the pet toy of FIG. 1;

FIG. 3 is left-side view of the pet toy of FIG. 1;

FIG. 4 is a top view of the pet toy of FIG. 1;

FIG. 5 is a perspective view of another example pet toy;

FIG. 6 is a front view of the pet toy of FIG. 5;

FIG. 7 is a rear view of the pet toy of FIG. 5;

FIG. 8 is a left-side view of the pet toy of FIG. 5;

FIG. 9 is a top view of the pet toy of FIG. 5;

FIG. 10 is a bottom view of the pet toy of FIG. 5;

FIG. 11 is a perspective view of the pet toy of FIG. 5 showing first and second portions of the pet toy in a disconnected configuration;

FIG. 12 is a perspective view of another example pet toy;

FIG. 13 is a front view of the pet toy of FIG. 12;

FIG. 14 is a rear view of the pet toy of FIG. 12;

FIG. 15 is a left-side-side view of the pet toy of FIG. 12;

FIG. 16 is a top view of the pet toy of FIG. 12;

FIG. 17 is a bottom view of the pet toy of FIG. 12;

FIG. 18 is a perspective view of the pet toy of FIG. 12 showing first and second portions of the pet toy in a disconnected configuration;

FIG. 19 is a perspective view of another example pet toy;

FIG. 20 is a front view of the pet toy of FIG. 19;

FIG. 21 is a rear view of the pet toy of FIG. 19;

FIG. 22 is a left-side-side view of the pet toy of FIG. 19;

FIG. 23 is a top view of the pet toy of FIG. 19;

FIG. 24 is a bottom view of the pet toy of FIG. 19; and

FIG. 25 illustrates various dimensions of the pet toy of FIG. 19.

### DETAILED DESCRIPTION

The following description refers to the accompanying drawings, which illustrate specific embodiments of the present disclosure. Other embodiments having different structures and operation do not depart from the scope of the present disclosure.

In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

As described herein, when one or more components are described as being connected, joined, affixed, coupled, attached, or otherwise interconnected, such interconnection may be direct as between the components or may be indirect such as through the use of one or more intermediary components. Also as described herein, reference to a “member,” “component,” or “portion” shall not be limited to a single structural member, component, or element but can include an assembly of components, members, or elements. Additionally, as used herein, the term “exemplary” is intended to mean serving as an illustration or example of something and is not intended to indicate a preference.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; and X employs both A and B. In addition, the articles “a” and “an” as used in this application and the appended claims should generally be construed to mean “one or more” unless specified otherwise or clear from the context to be directed to a singular form.

Numerical values or ranges stated herein are understood to encompass values at or near the stated value and/or above or below the stated range. For this application, the stated value can encompass plus or minus 5% of the value and the stated range can encompass plus or minus 5% of the extent of the range. In addition, the stated value or range can include a margin of error for the value or range typical in the art for the property being measured. The stated value or range can also encompass those values and ranges that would be considered equivalent to the stated value or range by one of ordinary skill in the art. As an example, a distance expressed as a range of 2 inches to 12 inches is understood to include durations above and below the ends of the range by 5% of the extent of the 10 inch range—e.g., 1.5 inches to 12.5 inches. As another example, the size of an object expressed as a value of 5 inches includes values above and below 5 inches that are within the margin of error of a tool typically used to measure objects of that size. As yet another example, an angle between two components expressed as a value of 20 degrees includes values above and below 20 degrees that would be considered equivalent by one of ordinary skill in the art.

The pet toys described herein are configured to continue motion after a user engages the pet toy 100 to start the motion of the pet toys. For example, the pet toys described herein can be sized and/or shaped and/or made of a material that allows for the pet toys to continue motion once motion begins. In some examples, the pet toys can have engagement portions that facilitate movement of the pet toys.

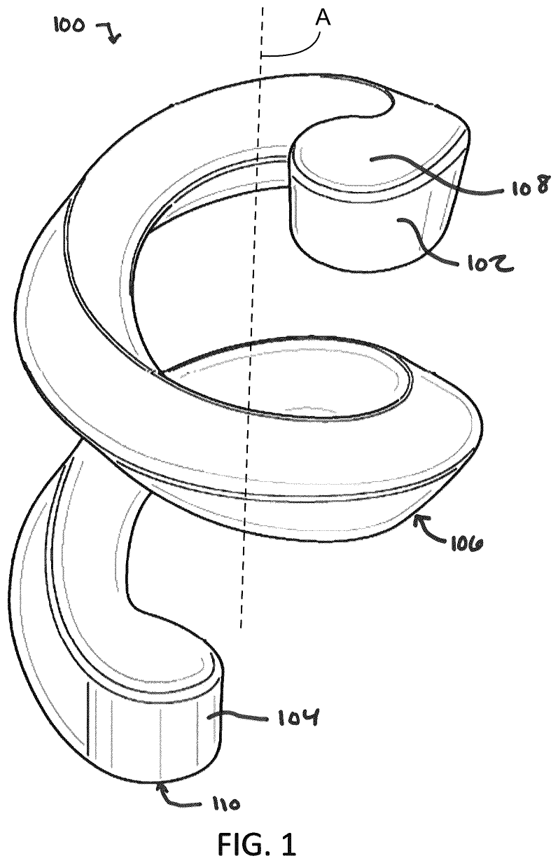

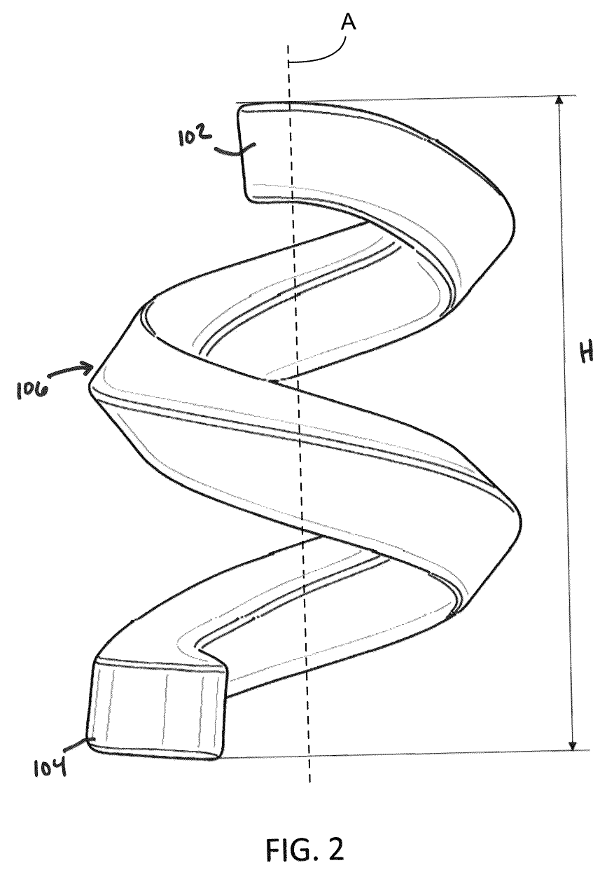

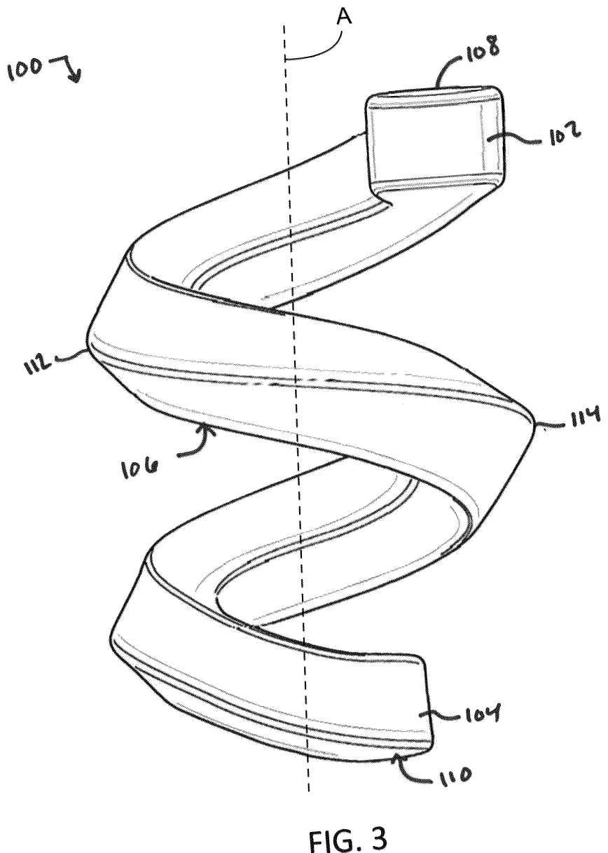

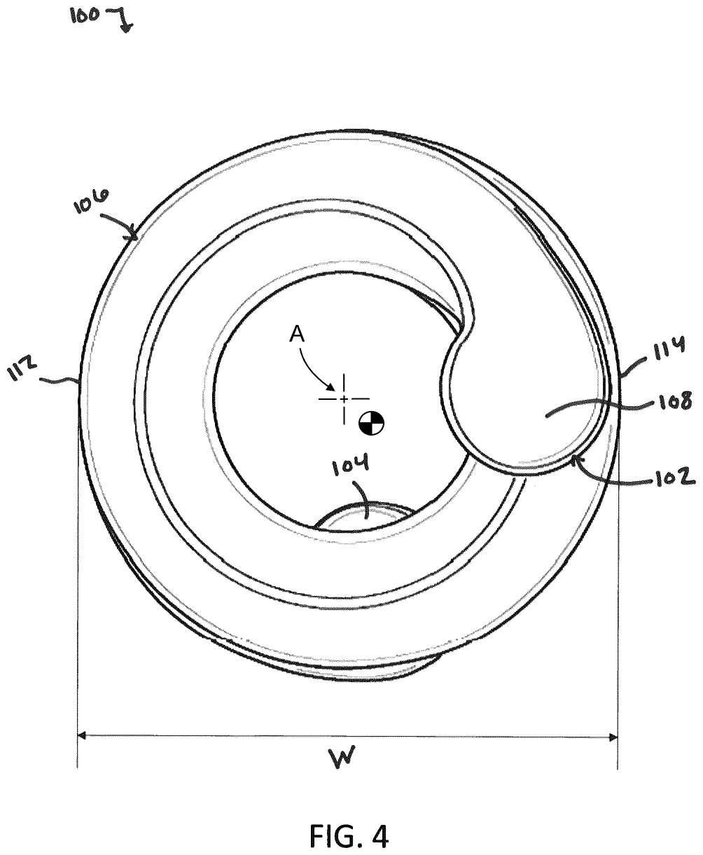

FIGS. 1-4 illustrate an example pet toy 100 that is configured to continue motion after a user engages the pet toy 100 to start the motion of the pet toy 100. The pet toy 100 has a first end 102, a second end 104, and a body portion 106 that extends between the first and second ends 102, 104. The body portion 106 can take a helical form. The pet toy 100 can have a heigh H (FIG. 2) of between about 120 mm and about 200 mm, such as about 137 mm or about 181 mm. In some examples, the exterior edges 112, 114 (FIG. 4) of the body portion 106 define the width W (FIG. 4) of the pet toy 100. The width W can be between about 70 mm and about 120 mm, such as about 87 mm or about 113 mm. In these examples, the helical shape of the body portion 106 can facilitate movement of the pet toy 100 due to the exterior edges being in engagement with a play surface (e.g., floor surface) during play, which can allow for the pet toy 100 to have a rolling motion. In the illustrated example, the main body 106 of the pet toy has a rectangular cross-section, but it should be understood that the main body 106 can have any other suitable cross-section.

The first and second ends 102, 104 are free ends of the pet toy 100 such that an engagement force between a play surface and the first and second ends can cause the first and second ends to compress toward the main body 106 and act as a spring to facilitate movement of the pet toy 100. In the illustrated example, the first and second ends 102, 104 have rounded exterior surfaces 108, 110 for engagement with the play surface, but it should be understood that the first and second ends can have any other suitable shape for the exterior surfaces that are capable of engaging with a play surface to facilitate motion of the pet toy 100.

The pet toy 100 can be made of, for example, thermoplastic rubber (TPR), which can facilitate movement due the flexibility of the material. However, it should be understood that the pet toy 100 can be made of any other suitable material that is capable of facilitating movement of the pet toy 100 and having durability to inhibit a pet from fracturing the pet toy during play 100.

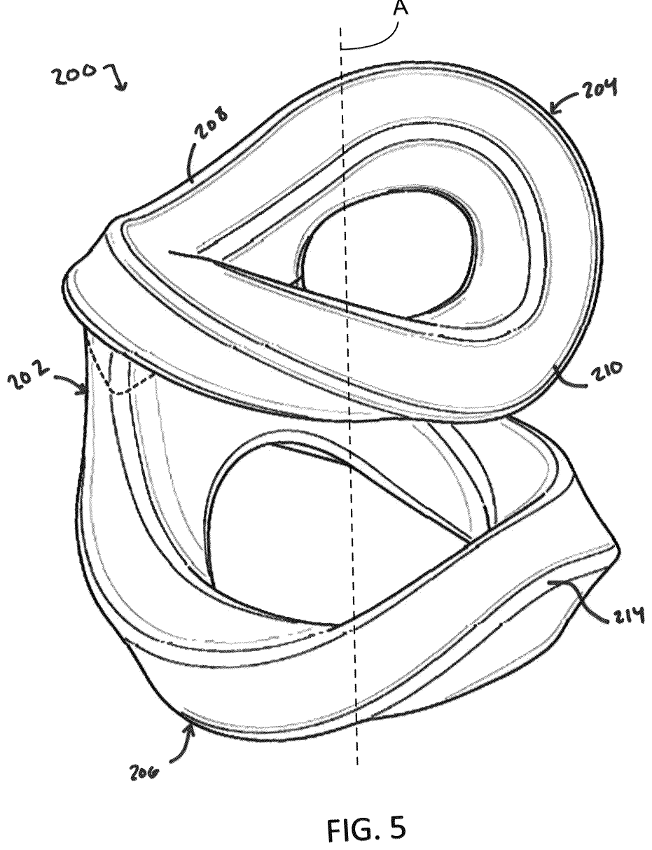

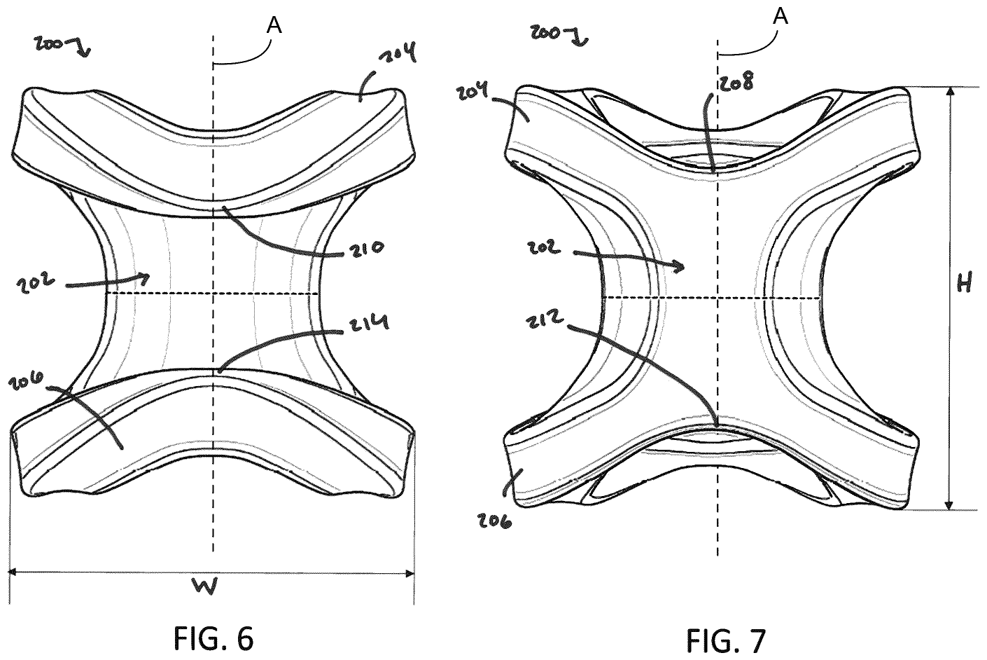

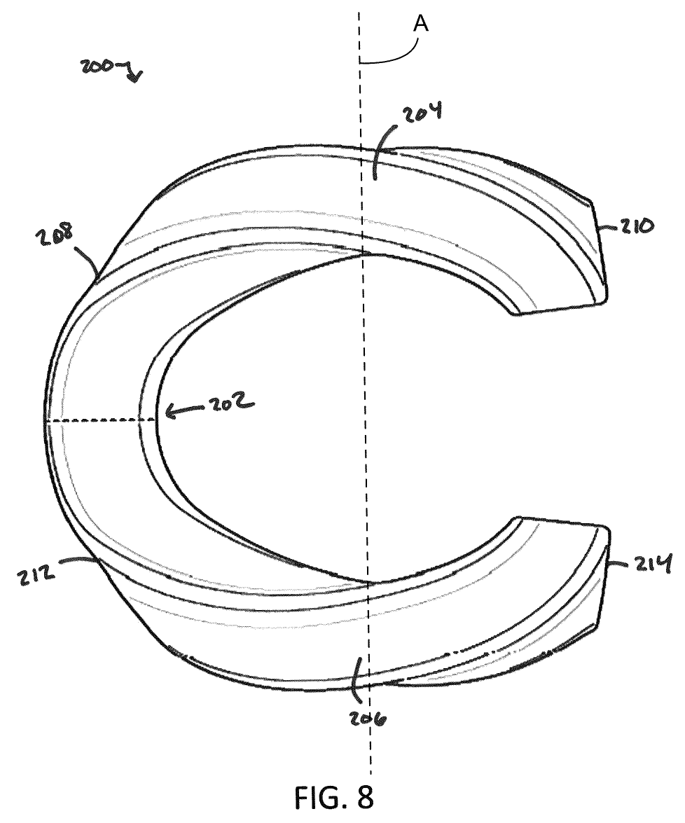

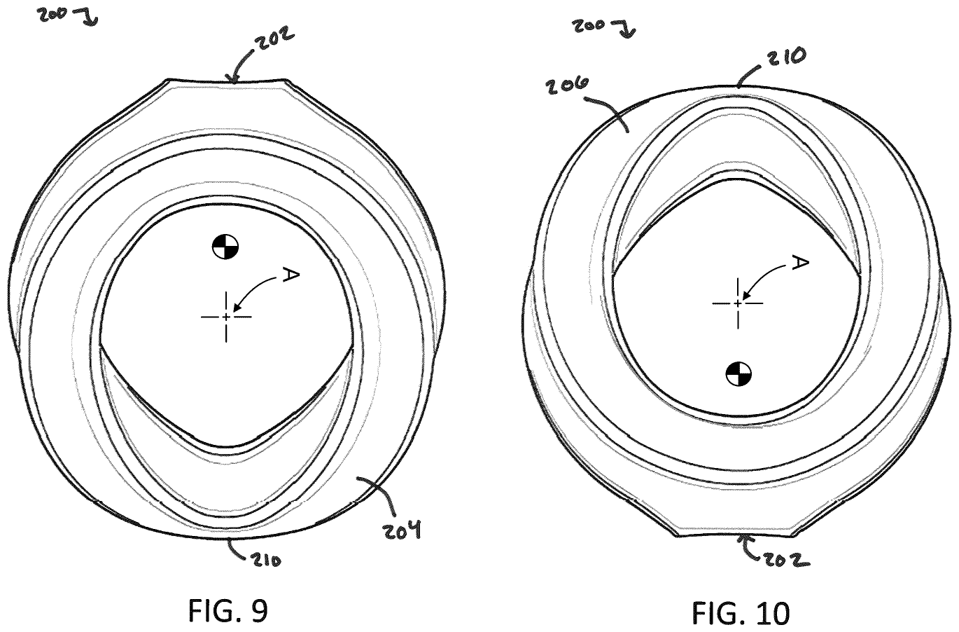

FIGS. 5-11 illustrate an example pet toy 200 that is configured to continue motion after a user engages the pet toy 200 to start the motion of the pet toy. The pet toy 200 has a body portion 202, a top member 204 that extends from a top edge of the body portion 202, and a bottom member 206 that extends from a bottom edge of the body portion 202. The top member 204 has a shape that resembles a potato chip or a saddle—i.e., a roughly hyperbolic paraboloid shape—having a fixed, rear edge 208 that is attached to the body portion 202 and a free edge 210 that extends to a front of the pet toy 200. The bottom member 206 also has a hyperbolic paraboloid shape having a fixed, rear edge 212 that is attached to the body portion 202 and a free edge 214 that extends to a front of the pet toy 200. The roughly hyperbolic paraboloid shape of the top and bottom members 204, 206 define a width W of the pet toy 200. The width W can be between about 50 mm and about 150 mm, such as about 90 mm or about 114 mm. The roughly hyperbolic paraboloid shape of the of the top and bottom members can facilitate movement of the pet toy 100 due to their exterior edges being in engagement with a play surface (e.g., floor surface) during play, which can allow for the pet toy 200 to have a rolling motion. The pet toy 200 can have a height H of between about 70 mm and about 130 mm, such as about 90 mm or about 114 mm. In some examples, the width W and height H of the pet toy 200 are equal. In the illustrated example, the top and bottom members 204, 206 of the pet toy have a rectangular cross-section, but it should be understood that the top and bottom members 204, 206 can have any other suitable cross-section. The top and bottom members 204, 206 are free ends of the pet toy 200 such that an engagement force between a play surface and the top and bottom members 204, 206 can cause the top and bottom members 204, 206 to compress inward and act as a spring to facilitate movement of the pet toy 200.

The pet toy 200 can be made of, for example, thermoplastic rubber (TPR), which can facilitate movement due the flexibility of the material. However, it should be understood that the pet toy 200 can be made of any other suitable material that is capable of facilitating movement of the pet toy 200 and having durability to inhibit a pet from fracturing the pet toy during play 200.

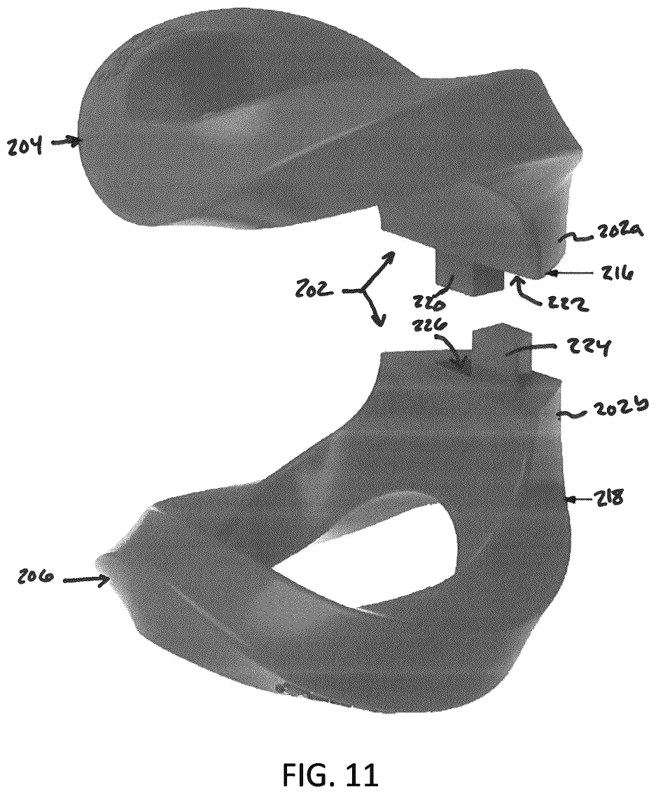

Referring to FIG. 11, in some examples, the pet toy can be made of two components 216, 218 that are connected together. For example, a first component 216 can include a top portion 202a of the body portion 202 and the top member 204, and a second component 218 can include a bottom portion 202b of the body portion 202 and the bottom member 206. The first component 216 can include a first connector 220 and a first opening 222, and the second component 218 can include a second connector 224 and a second opening 226. The first connector 220 of the first component 216 can be insertable into the second opening 226 and the second connector 224 of the second component 218 can be insertable into the first opening 220 to connect the first and second components 216, 218 together. However, it should be understood that the first and second components 216, 218 can be connected by any other suitable means.

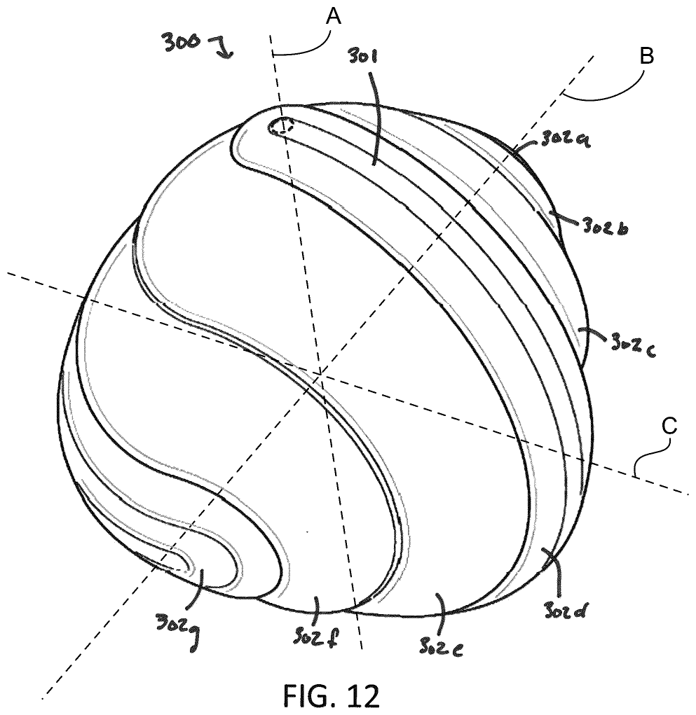

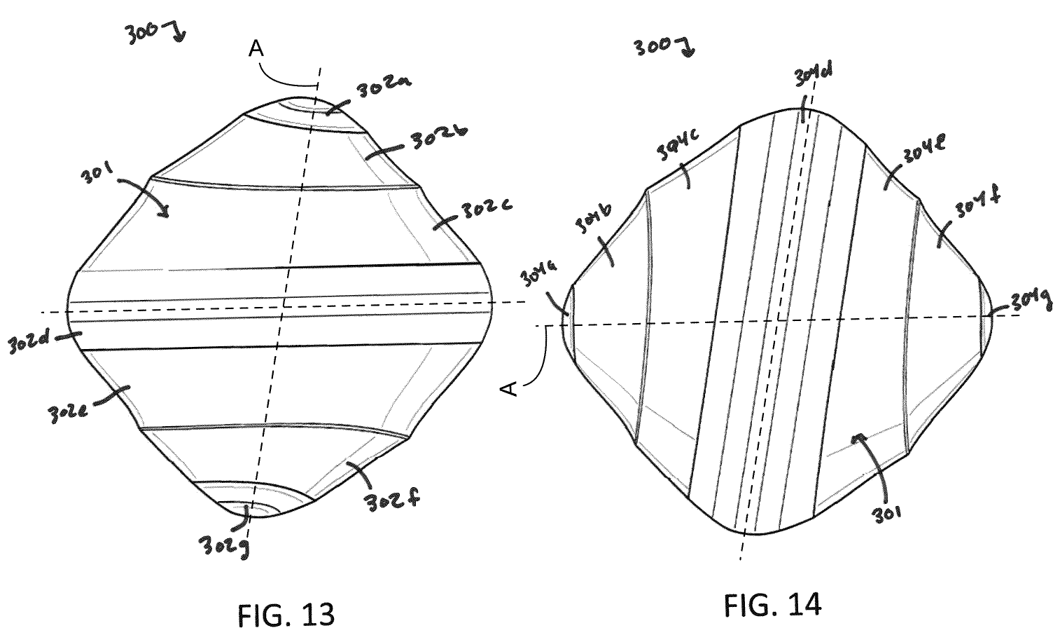

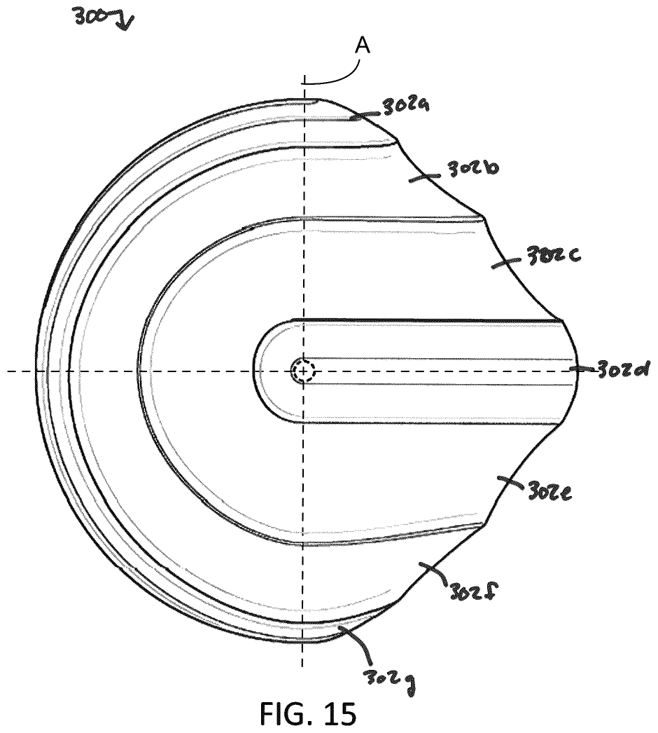

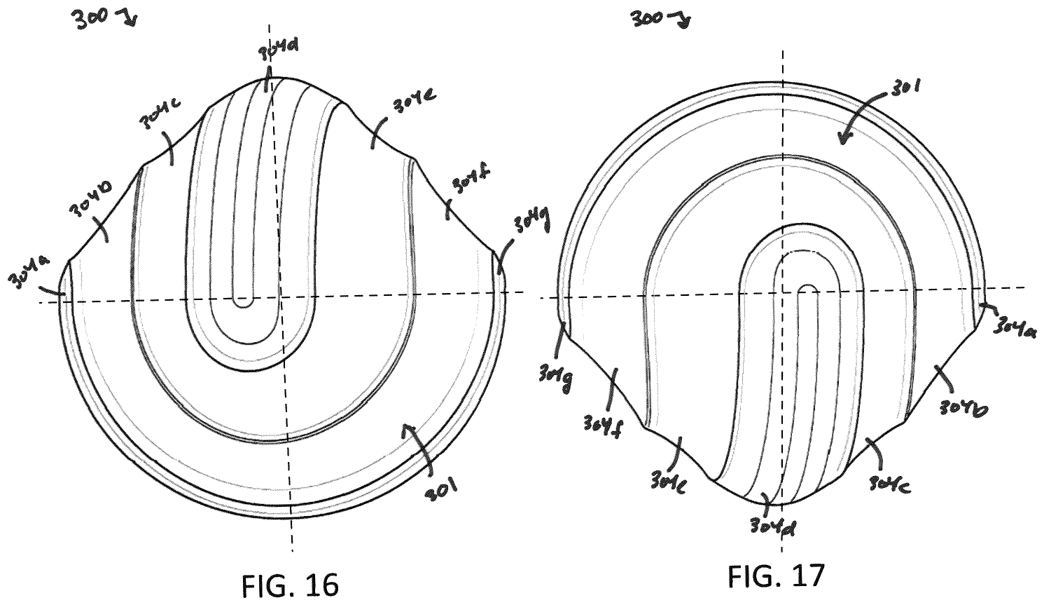

FIGS. 12-18 illustrate an example pet toy 300 that is configured to continue motion after a user engages the pet toy 300 to start the motion of the pet toy. Referring to FIGS. 12-13 and 15, the pet toy 300 has a body 301 having a plurality of portions 302a-302g that have increasing widths from a top portion 302a to the middle portions 302d, and from a bottom portion 302g to a middle portion 302d, such that the width of the middle portion 302d has the largest width of the pet toy 300. The portions 302a-302g having varying widths and the edges between adjacent portions are configured to cause an erratic rolling pattern. The pet toy 300 can have a largest width of between about 50 mm and about 100 mm, such as about 76 mm. Referring to FIGS. 14 and 16-17, the body 301 having a plurality of portions 304a-304g that have increasing heights from a first side portion 304a to the middle portions 304d, and from the other side portion 304g to a middle portion 304d, such that the height of the middle portion 304d has the largest height of the pet toy. The portions 304a-304g having varying heights and the edges between adjacent portions are configured to cause an erratic rolling pattern. The round shape of the pet toy 300 facilitates movement of the pet toy 300 in a rolling motion. The pet toy 300 can have a height of between about 50 mm and about 100 mm, such as about 75 mm.

The pet toy 300 can be made of, for example, thermoplastic rubber (TPR), which can facilitate movement due the flexibility of the material. However, it should be understood that the pet toy 300 can be made of any other suitable material that is capable of facilitating movement of the pet toy 300 and having durability to inhibit a pet from fracturing the pet toy during play 300.

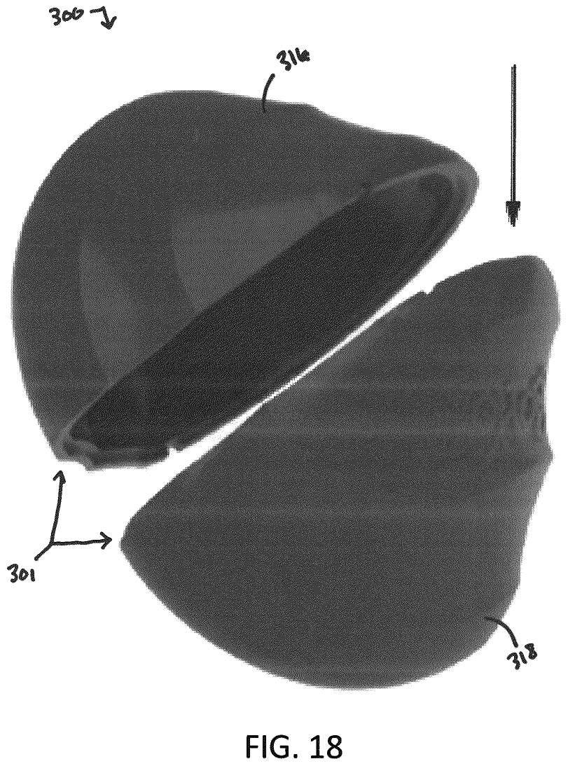

Referring to FIG. 18, in some examples, the pet toy 300 can be made of two components 316, 318 that are connected together. For example, a first component 316 can be connected to the second component 318 by a snap-fit connection. However, it should be understood that the first and second components 316, 318 can be connected by any other suitable means.

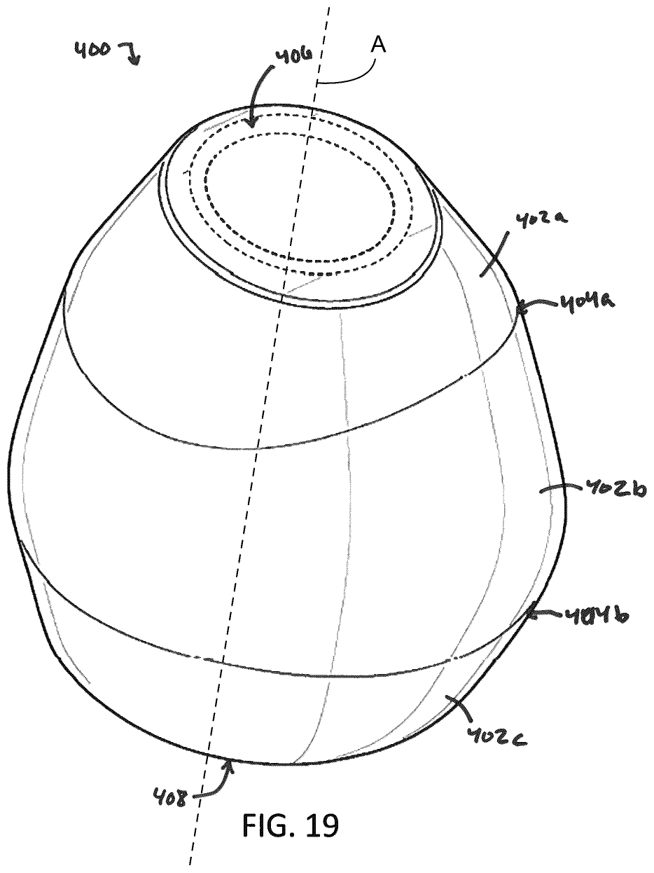

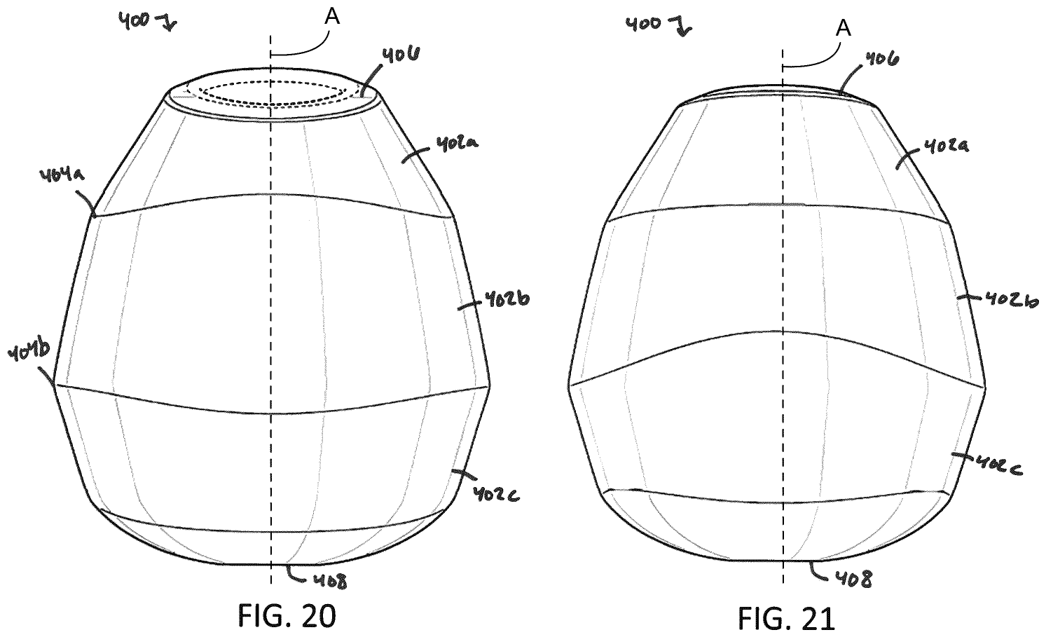

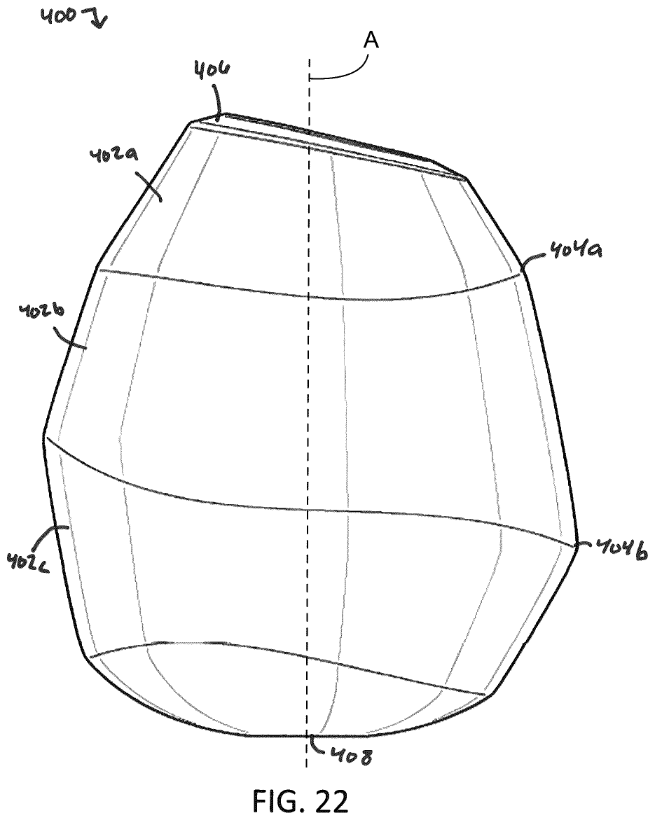

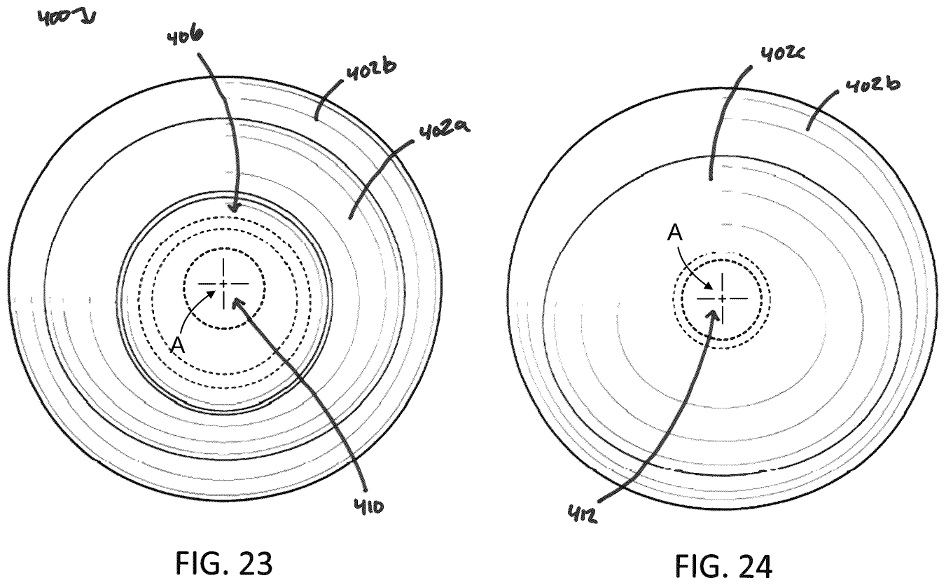

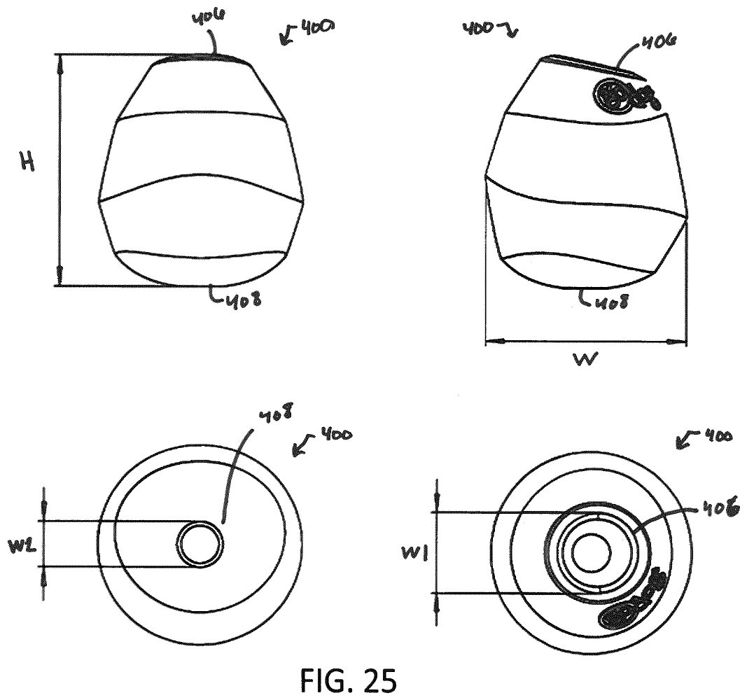

FIGS. 19-25 illustrate an example pet toy 400 that is configured to continue motion after a user engages the pet toy 400 to start the motion of the pet toy. The pet toy 400 has a body 401 having a first surface 402a, a second surface 402b, and a third surface 402c. The first surface 402a and the second surface 402b are connected at an edge 404a, and the second surface 402b and the third surface 402c are connected at an edge 404b. Each of the edges 404a, 404b has an irregular shape such that the pet toy 400 moves erratically when rolled. The round shape of the pet toy 400 facilitates movement of the pet toy 400 in a rolling motion. Referring to FIG. 25, the pet toy 400 can have a height H of between about 60 mm and about 100 mm, such as about 88 mm, and the pet toy 400 can have a width W of between about 50 mm and about 100 mm, such as about 76 mm.

Still referring to FIGS. 19-25, the pet toy 400 can have a top surface 406 and a bottom surface 408. The top surface 406 can have an opening 410 that is in communication with an interior cavity such that a user can insert pet food into the cavity. The top surface 406 can have a width W2 (FIG. 25) of between about 20 mm and about 40 mm, such as about 30 mm. The bottom surface 406 can have an opening 412 that is in communication with the interior cavity such that a user can insert pet food into the cavity. The openings 410, 414 can have a width W2 (FIG. 25) of between about 15 mm and about 25 mm, such as about 17 mm.

The pet toy 400 can be made of, for example, thermoplastic rubber (TPR), which can facilitate movement due the flexibility of the material. However, it should be understood that the pet toy 400 can be made of any other suitable material that is capable of facilitating movement of the pet toy 400 and having durability to inhibit a pet from fracturing the pet toy during play 400.

Referring to FIGS. 1-25, the pet toys 100, 200, 300, 400 can each have a first axis A arranged along, for example, a longitudinal direction of the pet toy 100, 200, 300, 400. Some of the pet toys also include second axes B and third axes C that are each perpendicular to the first axis A. The pet toys 100, 200, 300, 400 can be configured to continue rolling after being pushed by a pet because a center of mass of the pet toy is offset from, for example, the first axis A so that the pet toy tends to wobble or be unstable when the center of mass is above the first axis A.

The pet toys described herein also be encouraged to continue rolling when pushed by a pet because the pet toys contact a play surface in small portions of raised edges that wrap around the pet toy. The edges can, for example, wrap around the three-dimensional shape of the pet toy by enclosing the first axis A of the pet toy as can be seen in FIGS. 19-25. The pet toy can also include edges that wrap around and do not enclose at least one of a second axis B and a third axis C, as can be seen in FIGS. 12-17.

While various inventive aspects, concepts and features of the inventions may be described and illustrated herein as embodied in combination with exemplary embodiments, these various aspects, concepts and features may be used in many alternative embodiments, either individually or in various combinations and sub-combinations thereof. Unless expressly excluded herein, all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein.

Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

What is claimed:

1. A pet toy comprising:
a body portion having a helical shape, wherein the body portion defines an outer width of the pet toy;
a first end portion that extends from a top end of the body portion, wherein the first end is a free end of the pet toy; and
a second end portion that extends from a bottom end of the body portion, wherein the second end is a free end of the pet toy.

2. The pet toy according to claim 1, wherein the body portion has a rectangular cross-section.

3. The pet toy according to claim 2, wherein one or more corners of the rectangular cross-section defines a rolling edge for engaging a play surface.

4. The pet toy according to claim 3, wherein surfaces adjacent to the rolling edge are sloped so that the pet toy tends to contact the play surface on a plurality of locations along the rolling edge.

5. The pet toy according to claim 3, wherein a center of mass of the pet toy is offset from a center axis of the helical shape of the body portion.

6. A pet toy comprising:
a body portion;
a top member that extends from a top end of the body portion, wherein the top member comprises a saddle shaped loop; and
a bottom member that extends from a bottom end of the body portion, wherein the bottom member comprises a saddle shaped loop.

7. The pet toy according to claim 6, wherein the saddle shaped loops of the top member and the bottom member have rectangular cross-sections.

8. The pet toy according to claim 7, wherein one or more corners of the rectangular cross-section defines a rolling edge for engaging a play surface.

9. The pet toy according to claim 8, wherein surfaces adjacent to the rolling edge are sloped so that the pet toy tends to contact the play surface on a plurality of locations along the rolling edge.

10. The pet toy according to claim 8, wherein a center of mass of the pet toy is offset from a central axis extending through both of the saddle shaped loops of the top member and the bottom member.

11. A pet toy comprising:
a plurality of surfaces joined together by a plurality of edges to form a three-dimensional body;
a first contact surface between the pet toy and a play surface, wherein the first contact surface is disposed on one of the plurality of edges; and
a second contact surface between the pet toy and the play surface, wherein the second contact surface is disposed on another of the plurality of edges or one of the plurality of surfaces.

12. The pet toy of claim 11, wherein the first contact surface is disposed on a first edge and the second contact surface is disposed on a second edge.

13. The pet toy of claim 11, wherein a first distance between a center of mass of the pet toy is greater than a second distance between the first contact surface and the second contact surface.

14. The pet toy of claim 11, wherein at least one edge of the plurality of edges encloses a first axis of the three-dimensional body.

15. The pet toy of claim 14, wherein each edge of the plurality of edges encloses the first axis of the three-dimensional body.

16. The pet toy of claim 15, wherein the three-dimensional body has an egg shape.

17. The pet toy of claim 14, wherein the at least one edge of the plurality of edges does not enclose a second axis of the three-dimensional body, wherein the second axis is orthogonal to the first axis.

18. The pet toy of claim 17, wherein at least one edge of the plurality of edges does not enclose a third axis of the three-dimensional body, wherein the third axis is orthogonal to at least one of the first axis and the second axis.

19. The pet toy of claim 18, wherein each edge of the plurality of edges forms a saddle shape.

20. The pet toy of claim 18, wherein the three-dimensional body has a clamshell shape.
